(19) United States
(12) Patent Application Publication
(10) Pub. No.: US 2024/0247159 A1
(43) Pub. Date: Jul. 25, 2024

(54) METHOD FOR MANUFACTURING A LUMINESCENT PRINTING INK

(71) Applicant: GIESECKE+DEVRIENT CURRENCY TECHNOLOGY GMBH, Munchen (DE)

(72) Inventor: Kai Uwe STOCK, Grunwald (DE)

(21) Appl. No.: 18/562,104

(22) PCT Filed: May 25, 2022
(86) PCT No.: PCT/EP2022/025242

§ 371 Date: Nov. 17, 2023

(30) Foreign Application Priority Data
May 27, 2021 (DE) 10 2021 002 764.7

(51) Int. Cl. C09D 11/037; B41M 3/14

(52) U.S. Cl. CPC C09D 11/037; B41M 3/144

(57) ABSTRACT

A method for producing a luminescent printing ink of a desired target spectral locus in which: Z) the desired target spectral locus is specified using standard chromaticity coordinates x, y; L) at least two luminescent pigments are specified by their luminescence spectra; B) from the luminescent spectra of the luminescent pigments, from spectral value functions, and from the specified target spectral locus, proportions by weight of the at least two luminescent pigments are determined, and M) the at least two luminescent pigments are mixed in the proportions by weight deter-mined in step B) in order to obtain a luminescent printing ink having a luminescence of which the spectral locus under illumination with non-visible excitation light corresponds substantially to the target spectral locus.

### BACKGROUND

The invention relates to a method for producing a luminescent printing ink, as well as a method for generating a luminescent color image using one or more such luminescent printing inks. The luminescent color image can in particular be a security element for securing a data storage means, e.g., a valuable document or an identity document.

Data storage means, e.g., valuable documents or identification documents, but also other valuable objects like branded articles, are often provided with security elements in order to enable verification of the authenticity of the data storage means and which also serve as protection against prohibited reproduction. In this context, it is known to use luminescent substances to secure valuable documents or identity documents. The presence of the luminescent substances can then be tested, e.g., with the aid of a UV lamp.

Regarding more complex luminescent features, there is often a desire to reproduce one or more specified diffuse reflectance printing inks in luminescent printing. For example, it can be desirable to render a specified diffuse reflectance color image or real-world object as a real color luminescent print. Publication EP 1 013 463 B1 discloses to provide a first color photo portrait image on a recording medium, which is printed using color inks of cyan, magenta, and yellow. A second color photo portrait image is printed using fluorescent UV or IR inks of red, green, and blue, and the image data of the second color photo portrait image is printed using complementary colors to the image data of the first color photo portrait image obtained by reversing the densities for the color inks cyan, magenta, and yellow. The second color photo portrait image then has largely the same shape and color as the first color photo portrait image and can be utilized to confirm it. However, this printing method is only suitable for screen printing methods, while other printing methods such as Intaglio printing are often used in valuable document printing, and the desired color impression is achieved by using printing ink mixed from primary printing inks. More-over, in the known method, effects due to overprinting of multiple printing inks are not considered, so the color impression from the resulting luminescent portrait image, in particular on a colored background, only corresponds to a limited extent to that of the diffuse reflectance portrait image.

DE 10 2019 008 116 A1 discloses a luminescent print that partially overlaps with a diffuse reflectance print. The overlapping and non-overlapping portions provide the same specified luminescent color impression. The specified spectral locus is in this case found by trial and error with multiple sample impressions.

### SUMMARY

On this basis, the object of the invention is to specify a method of the type specified hereinabove, by means of which a desired target spectral locus can be optimally replicated, including its hue and saturation, using a luminescent printing ink. The invention is also intended to provide a method for generating a luminescent printing ink image using one or more such luminescent printing inks.

According to the invention, in a method for producing a luminescent printing ink of a desired target color in a step Z), the desired target color is specified using standard chromatic value fractions x, y.

During step L), at least two, in particular at least three luminescent pigments are specified by their luminescent spectra. During step B), from the luminescent spectra of the luminescent pigments, from spectral value functions, in particular CIE spectral value functions, and from the specified target color, in particular relative, proportions by weight of the at least two luminescent pigment are determined.

Finally, during step M), the at least two luminescent pigments are mixed in the proportions by weight determined during step B), in particular relatively, in order to obtain a luminescent printing ink having a luminescence of which the spectral locus under non-visible excitation light corresponds substantially to the desired target spectral locus.

Preferably, at least in particular exactly, three luminescent pigments are used. In other words, during step L), at least three luminescent pigments are specified by their luminescent spectra. During step B), relative proportions by weight of the at least three luminescent pigments are deter-mined and, during step M), the at least three luminescent pigments are mixed in the relative proportions by weight determined during step B). In this way, a plurality of luminescent spectral loci can be represented that lie in a flat area of the CIE standard color space.

In the context of the present description, non-visible excitation light means light outside the visible spectral range of 380 nm to 780 nm, specifically UV light in the spectral range of 10 nm to 380 nm, preferably from 200 nm to 380 nm, or IR light in the spectral range of 780 nm to 30 μm, preferably from 780 nm to 3000 nm. UV excitation can occur in particular in the long-wave UV at an excitation wavelength of 365 nm, or in the short-wave UV at an excitation wavelength of 254 nm.

In the context of the present description, the term “luminescent” in particular comprises phosphorescence and fluorescence, whereby the excitation of the luminescence is performed using the non-visible excitation light specified. The specified luminescent pigments are preferably transparent in the visible spectral region.

During the course of a preferred method, the luminescent spectra of the luminescent pigments and the spectral value functions, in particular the CIE spectral value functions, are each specified as vector of n intensities at n defined wavelengths. Further, during step B):
B1) color valences X′, Y′ Z′ are determined from the standard chromaticity coordinates x, y of the specified target spectral locus,
B2) a luminescent color matrix is determined from the luminescent spectra of the luminescent pigments and the spectral value functions, in particular the CIE spectral value functions,
B3) the luminescent color matrix is inverted in order to obtain an inverse luminescent color matrix, and
B4) the relative proportions by weight of the at least two luminescent pigments are determined from the inverse luminescent color matrix and the color valences X′, Y′ Z′ of the specified target spectral locus.

This representation as vectors and matrices enables an efficient determination of the relative proportions by weight using methods from linear algebra.

The length n of the spectral vector can, e.g., be at least n=10, particularly n=50, or n=100. For example, the n determined wavelengths can be equidistant on the visible spectral range between 380 nm and 780 nm.

Advantageously, during step M) of the method:
M1) a total pigmentation of the luminescent pigments or a maximum pigmentation of one of the luminescent pigments is specified, and the absolute proportions by weight of the at least two luminescent pigments are thereby determined from the relative proportions by weight determined during step B), and
M2) the at least two luminescent pigments are mixed in the absolute weight fraction determined during step M1 and introduced into a clear coat in order to obtain the luminescent printing ink.
   In this way, it is possible for the luminescent printing ink to have the properties necessary for the desired printing process.

In one advantageous embodiment of the method, it is provided that:
during step Z), a desired color distance tolerance to the target spectral locus is specified in addition to the desired target spectral locus,
during step B), while further using the specified color distance tolerance, a tolerance weight range for the relative weight fraction of each of the at least two luminescent pigments is in each case determined, and
during step M), the at least two luminescent pigments are mixed in proportions by weight, each within the tolerance weight ranges for the luminescent pigments, in order to obtain a luminescent printing ink having a luminescence of which the spectral locus under non-visible excitation light corresponds substantially to the desired target spectral locus. This enables safer process control because the required metering accuracy is known.

During step B), in addition to the luminescent spectra of the luminescent pigments, the spectral value functions, in particular the CIE spectral value functions, and the specified target spectral locus, the specified color distance tolerance is also used to determine a tolerance weight range for the at least two luminescent pigments in addition to the relative proportions by weight.

It is further preferably provided with an advantage that, during step B):
B0) at least two, preferably at least four, boundary spectral loci with standard chromaticity coordinates xG, yG are determined from the specified target spectral locus and the specified color distance tolerance, in particular assuming the same brightness,
B2) a luminescent color matrix is determined from the luminescent spectra of the luminescent pigments and the spectral value functions, in particular the CIE spectral value functions,
B3) the luminescent color matrix is inverted in order to obtain an inverse luminescent color matrix.
   It is further provided that, for each boundary spectral locus:
B1′) color valences XG′, YG′, ZG′ associated with the boundary spectral locus are deter-mined from the standard chromaticity coordinates xG, yG,
B4′) from the inverse luminescent color matrix and the determined color valences XG′, YG′ ZG′ of the boundary spectral locus, relative proportions by weight associated with the at least two luminescent pigments are determined,
   and then
B5′), a tolerance weight range for the relative weight fraction of each of the at least two luminescent pigments is determined from the relative proportions by weight of the at least two luminescent pigments for the boundary spectral loci.
   In this way, the tolerance weight ranges can be safely determined taking into account the visual perception at the target color.

The invention further relates to a method for generating a luminescent color image, in particular a multi-colored luminescent color image, in which
one or more of the luminescent colors found in the luminescent image is specified for a desired target spectral locus,
a luminescent printing ink is in each case produced for the specified target spectral loci using a method of the type described hereinabove, and
the luminescent color image is printed using the luminescent printing inks produced.

During the method, a multi-colored diffuse reflectance color image is advantageously specified, which in the visible light in different respective sub-areas provides a color impression or a specific color effect determined by a spectral locus. A luminescent color image is further generated that reproduces the color impression or the color effect of the diffuse reflectance color image by recognizing the spectral locus of the diffuse reflectance color in the visible light for the various sub-areas as the desired target spectral locus for the luminescent color.

Preferably, the diffuse reflectance color image with diffuse reflectance printing inks and the luminescent image with the luminescent printing inks produced are imprinted on the same target data storage means.

In a preferred embodiment, the luminescent color image is imprinted on the data storage means as a security element for securing a data storage means, in particular a valuable document or an identity document.

The data storage means can in particular be a valuable document, like a bank note, in particular a paper bank note, a polymeric bank note or a film composite bank note, about one share, a bond, a certificate, a voucher, a check, a seal, a control banderol, a high-end ticket but also a badge such as a credit card, a bank card, a cash payment card, a credential card, an identity card, or a passport personalization page.

The luminescent color image preferably depicts a portrayal, a real-world representation, in particular a representation of nature, a national flag, or another sovereign emblem or badge of honor, in particular a national one. In such color images, proper color rendering is particularly important or advantageous.

If a diffuse reflectance color image and a luminescent color image are present, both color images are advantageously printed on the data storage means, whereby the luminescent color image shows the same motif and generates the same color impression as the diffuse reflectance color image in visible light in order to secure the data storage means under excitation light. The presence of the luminescent color image and the true-to-color recreation of the diffuse reflectance color image represent a security feature that is easily verifiable, but difficult for counterfeiters to manip-ulate.

The luminescent color image can represent a 1:1 copy of the diffuse reflectance color image, but it can also be enlarged or smaller than the diffuse reflectance color image. The luminescent color image can be imprinted over the diffuse reflectance color image in a register-exact manner, it can partially overlap with the diffuse reflectance color image, or it can be imprinted without overlap in another area of the data storage means. In particular, when switching from visible light to excitation light, a motion effect can result.

The invention also relates to a printing ink produced according to the method according to the invention for producing a luminescent printing ink.

The invention further relates to a data storage means, preferably a valuable document, in particular a bank note, with an imprint comprising a printing ink according to the invention.

### BRIEF DESCRIPTION OF THE DRAWINGS

Further exemplary embodiments, as well as advantages of the invention, are explained hereinafter with reference to the drawings, the illustration of which is not true to scale, and proportional representation is made for the sake of greater clarity.

### Shown are:

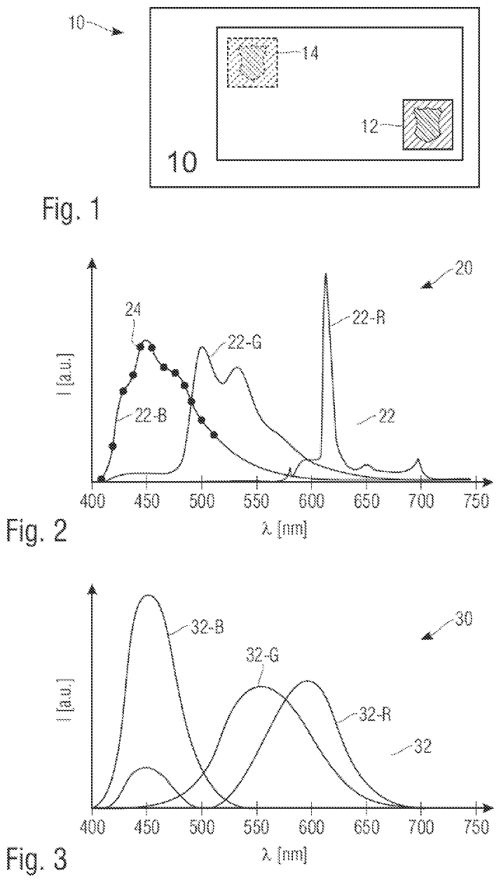

FIG. 1 a schematic illustration of a bank note with a multi-colored diffuse reflectance color image and a multi-colored luminescent image produced according to the present invention,

FIG. 2 schematically illustrates the continuous spectra of three selected luminescent pigments for the luminescent base colors red, green, and blue,

FIG. 3 the continuous spectra of the CIE spectral value functions for the colors red, green, and blue,

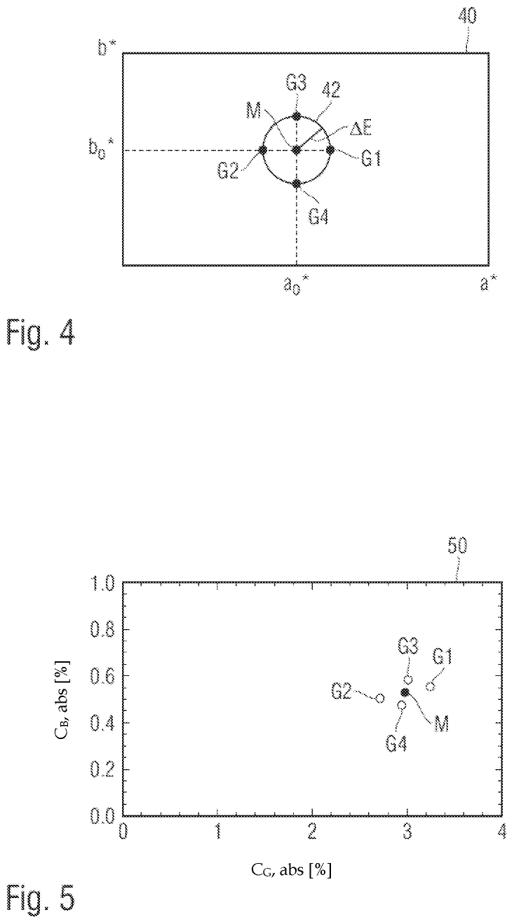

FIG. 4 an illustration of color distance tolerance as a circle in the a*, b* coordinate system around a target spectral locus, and

FIG. 5 for one embodiment, the obtained absolute proportions by weight c_{G,abs}, c_{B,abs} of the green and blue luminescent pigments for the center point M belonging to the target spectral locus and four boundary spectral loci G1 to G4.

### DETAILED DESCRIPTION OF VARIOUS EMBODIMENTS

The invention will be explained hereinafter using the example of a luminescent security element for bank notes. FIG. 1 shows a schematic representation of a bank note 10 with an imprint 12 in the form of a multi-colored diffuse reflectance color image, which can be seen in visible light under normal lighting conditions. The bank note 10 further comprises a security element 14 in the form of a luminescent color image, which is not detectable in visible light, but only appears when the bank notes are illuminated by non-visible excitation light, e.g., UV light.

The luminescent color image 14 depicts the same motif as the diffuse reflectance color image 12, with the luminescent printing inks of the luminescent color image 14 being chosen as a special feature such that they generate the same color impression as the diffuse reflectance color image 12 in the visible light upon UV excitation. In the example, the luminescent printing inks used each contain at least three luminescent pigments, which are mixed in such a relative proportion and introduced into a clear coat that the luminescent of the luminescent printing ink optimally mimics the spectral locus, i.e., the hue and the saturation, of the respective target diffuse reflectance color.

The procedure for producing suitable luminescent printing inks is explained hereinafter on the basis of recreating the spectral locus of a specified diffuse reflectance color. One can proceed accordingly with regard to the further diffuse reflectance colors of a diffuse reflectance color image 12.

The specified diffuse reflectance color, including its brightness, can be described via the standard valences X, Y, and Z, which can, e.g., be determined by a spectrophotometric measurement. Such a measurement is always related to standard lighting, from which the white reference also results. However, for luminescent printing inks, standard lighting and a white reference are not defined, so the standard valences X, Y, Z cannot be used for luminescent printing inks.

According to the invention, this difficulty is circumvented by the fact that for the replication of the diffuse reflectance color, not the standard valences but rather the standard chromaticity coordinates x, y, and z are used, which are defined by

$$x = X / ( X + Y + Z ) ,$$

$$y = Y / ( X + Y + Z ) ,$$

$$z = Z / ( X + Y + Z ) .$$

The standard chromaticity coordinates x and y describe the spectral locus on the standard color space. Since the standard chromaticity coordinates are not related to a white reference, they can also be used to describe luminescent colors. Reference is made subsequently to the color valences X′, Y′, Z′ without standardization, which are proportional to both the standard valences X. Y. Z, and the standard chromaticity coordinates x, y, z.

In the next step, three luminescent pigments are selected for the primary colors red, green, and blue that are to be used for the recreation of the specified diffuse reflectance color and whose luminescent spectra are known. In the general case, only two or even k≥3 luminescent pigments with certain base luminescent printing inks are used, so the following explanation for the particularly relevant special case k=3 is performed for ease of representation. The base luminescent printing inks, also referred to as primary printing inks, are preferably phosphorescence printing inks that are colorless under visible lighting and visibly luminescent under lighting by excitation light, in particular UV light.

Spectra are each described as a vector of n intensities at set wavelengths in the context of this specification. The spectral vectors of the three selected luminescent primary colors can be gathered into an n×3 matrix, the so-called basic color matrix R. The graph 20 in FIG. 2 schematically shows the continuous spectra 22 of the three selected luminescent pigments for the lumines-cent primary colors red (22-R), green (22-G), and blue (22-B). In the luminescent pigment for the primary color blue, it is also indicated in the left half of the diagram, how a discrete spectrum consisting of n intensities 24 can be obtained from the continuous spectra by discretization, which forms the specified spectral vector.

The relative weight fraction of the luminescent pigments for the primary colors red, green, blue can be described by a metering vector c=(c_{R}, c_{G}, c_{B})^{T}, where the superscript T indicates a transposition that enables the column vector c to be written as a line vector for the more compact representation.

With the metering vector c, the mixing spectrum S_{M} of the luminescent printing ink obtained from the mixture of these three luminescent pigments can be determined by multiplying the basic color matrix R with the metering vector c, i.e.:

$${S}_{M} = R \cdot c .$$

The color valences X′, Y′. Z′ of the mixed printing ink can be obtained from the mixing spectrum S_{M} by decomposition into the CIE spectral value functions, in particular in accordance with DIN EN ISO 11664-1. To this end, a 3×n matrix, the standard light sensitivity matrix W, and the mixing spectrum s_{M} is multiplied by the standard light sensitivity matrix W, is formed from the three CIE spectral value functions. The three spectral value functions 32 for the colors red (32-R), green (32-G), and blue (32-B) are shown in the graph 30 in FIG. 3. These continuous spectra are also shown after discretization by a spectral vector from n intensities, respectively, so the three spectral value functions can be represented by the mentioned 3×n-standard light sensitivity matrix W.

Therefore, the following results for the color valences X′, Y′, Z′ of the mixed color:

$${( {X}^{′} , {Y}^{′} , {Z}^{′} )}^{T} = W \cdot {S}_{M} = W \cdot R \cdot c .$$

The luminescent color matrix A:=W·R is defined, which represents a 3×3 matrix and which establishes a relationship between the metering vector and the color valences of the mixed printing ink:

$${( {X}^{′} , {Y}^{′} , {Z}^{′} )}^{T} = A \cdot c .$$

In order to then inversely determine the associated metering vector, and thus the required proportions by weight of the three luminescent pigments based on the color valences X′, Y′, Z′ of the specified diffuse reflectance color, only the last matrix operation need be inverted. For this purpose, the luminescent color matrix A is inverted to obtain the associated inverse luminescent color matrix B=A⁻¹, so the following is true:

$$c = {A}^{- 1} \cdot {( {X}^{′} , {Y}^{′} , {Z}^{′} )}^{T} = B \cdot {( {X}^{′} , {Y}^{′} , {Z}^{′} )}^{T}$$

The components c_{R}, c_{G}, c_{B} contained in the metering vector c then indicate the relative proportions by weight into which the three selected luminescent pigments must be mixed in order to obtain a luminescent printing ink having a luminescence, the spectral locus of which exactly corresponds to the target spectral locus upon excitation, e.g., the target spectral locus X′, Y′, Z′ of the specified diffuse reflectance color.

In order to achieve absolute proportions by weight for the pigmentation of a color, the proportions by weight c_{R}, c_{G}, c_{B} must still be appropriately scaled, e.g., by determining the pigmentation of the luminescent pigment occurring in the highest concentration, or by determining the overall pigmentation.

For example, a metering vector with c_{R}=9.4, c_{G}=5.6, and c_{B}=1.0 for the readjustment of a specified diffuse reflectance color can result specifically from the calculation. If the color with the highest concentration is set to a desired pigmentation (in this case, e.g., the luminescent pigment for the color red on c_{R,abs}=5%), then the other pigmentations can be determined as:

$${c}_{G , a b s} = {c}_{G} * {c}_{R , a b s} {/}_{cR} = 3 \% ,$$

$$and$$

$${c}_{B , a b s} = {c}_{B} * {c}_{R , a b s} {/}_{cR} = 0.53 \% .$$

The luminescent pigments for the colors red, green, and blue are then introduced into a clear coat in proportions of 5%, 3%, and 0.53%, respectively, in order to obtain the desired luminescent printing ink.

In another variant, a desired overall pigmentation c_{tot,abs} of the luminescent printing ink can be provided, based on which the required pigmentations of the individual printing inks can be derived. For example, if c_{tot,abs}=10%, then cₜₒₜ=c_{R}+c_{G}+c_{B}:

$${c}_{R , a b s} = {c}_{R} * {c}_{tot , a b s} / {c}_{tot} = 5.875 \% ,$$

$${c}_{G , a b s} = {c}_{G} * {c}_{tot , a b s} / {c}_{tot} = 3.5 \% ,$$

$$and$$

$${c}_{B , a b s} = {c}_{B} * {c}_{tot , a b s} / {c}_{tot} = 0.625 \% .$$

The three luminescent pigments selected are then mixed in the absolute proportions by weight determined in this way and introduced into a clear coat. The luminescent printing ink thus obtained is preferably transparent in the visible light and luminescent after excitation with a luminescent printing ink, the spectral locus of which corresponds to the specified diffuse reflectance color.

The described procedure can be performed accordingly for the other diffuse reflectance printing inks of the diffuse reflectance color image 12 such that a set of luminescent printing inks is obtained, the luminescence of which in each case lies at the spectral locus of the associated diffuse reflectance color. Using this set of luminescent printing inks, the luminescent color image 14 in FIG. 1 is printed, thereby achieving the desired color-accurate reproduction of the diffuse reflectance color image 12.

If, in the general case, more than 3 base luminescent colors are specified, then the calculation scheme described hereinabove can be adjusted accordingly. The basic color matrix R is generally an n×k matrix in k-specified luminescent pigments, and the metering vector is a column vector with k proportions by weight cᵢ, i=1 . . . k for the k different luminescent pigments. The calculation is similar to the description hereinabove, and only with the inversion of the matrix A=W·R, the pseudo-inverse B must generally be used to determine the proportions by weight _{ci} from the color valences X′, Y′. Z′ of a specified diffuse reflectance color.

In one embodiment of the invention, not only a certain metering vector is calculated to rep-licate the spectral locus of a specified diffuse reflectance color as accurately as possible, but rather a color distance tolerance ΔE is additionally provided, within which the color imprint of the luminescence of the luminescent printing ink is intended to lie.

This extended procedure takes into account the fact that spectral loci close to one another are not or are almost indistinguishable to a human viewer. By incorporating a suitable chosen color distance tolerance, e.g., ΔΕ=1 or ΔΕ=3, a repeatability in the mixing of luminescent printing inks can be achieved, and it can be ensured that multiple mixtures of luminescent printing inks provide an indistinguishable color impression.

On the other hand, it can thereby also be ensured that, when a specified diffuse reflectance printing ink is recreated by a mixture of luminescent pigments using the luminescent printing ink, a color impression that is visually indistinguishable from the color impression from the diffuse reflectance printing ink is obtained. The specification of a color distance tolerance to be observed enables the requirements for the composition of the replicating luminescent printing inks to be quantified and thus also make a simpler quality control accessible.

For diffuse reflectance printing inks, the distinguishability of printing inks with selected lighting can be evaluated based on the color distance in the CIELAB color space or a related color space, e.g., the DIN99 color space. If the spectral locus of a diffuse reflectance color is specified with the standard valences X, Y, and Z, e.g., by a spectrophotometric measurement, then the coordinates L*, a*, b* of the spectral locus in the CIELAB color system can be calculated from these standard valences by way of transformation. L* indicates the brightness of the color, a* indicates the color type and color intensity between green and red, and b* indicates the color type and color intensity between blue and yellow.

The color difference ΔE between two spectral loci (L₁*, a₁*, b₁*) and (L₂*, a₂*, b₂*) is indicated in the CIELAB color space by

$$Δ E = √ ( {( {L}_{{1}^{*}} - {L}_{{2}^{*}} )}^{2} + {( {a}_{{1}^{*}} - {a}_{{2}^{*}} )}^{2} + {( {b}_{{1}^{*}} - {b}_{{2}^{*}} )}^{2} ) .$$

A color difference ΔE≤0.5 is in this case usually considered nearly imperceptible; a color difference ΔE=0.5-1.0 is considered to be noticeable to the skilled eye; a color difference ΔE=1.0-2.0 is a minor color difference; a color difference ΔE=2.0-4.0 is a perceptible color difference; a color difference of ΔE=4.0-5.0 is a significant and rarely tolerated color difference; and, regarding color differences ΔE≥5.0, both spectral loci are evaluated as being excessively different.

However, since the specified color spaces require a white point of the lighting used to be included, the methods used for the assessment of the distinguishability of luminescent colors for which no white point is defined cannot be used.

In order to circumvent this difficulty, the path is in particular taken over the standard chromaticity coordinates according to the invention. Briefly summarized, in addition to the spectral locus of the diffuse reflectance color to be replicated, in a suitable color system, for example the CIELAB or DIN99 color system, a tolerance color spacing ΔE is also specified, within which a color is considered indistinguishable from the eye in the desired application. The area defined by the tolerance color distance ΔE is then transformed around the spectral locus of the diffuse reflectance color to be replicated, assuming equal brightness in standard chromaticity coordinates x, y. The transformed area can, e.g., be indicated by a plurality of boundary spectral loci, each indicating minimum or maximum coordinates of a direction in the color space. Based on these boundary spectral loci, metering vectors for the proportions by weight of the luminescent pigments are determined as described hereinabove, and based on the dosing vectors for the boundary spectral loci, a tolerance weight range for the concentration of the luminescent pigments is derived, within which luminescent color mixtures feature an indistinguishable color impression.

Specifically, the determination of the boundary spectral loci for the recreation of a specified diffuse reflectance color can be made, taking into account a specified tolerance color spacing, e.g., as follows:

The target spectral locus of the diffuse reflectance color is specified using the standard chromaticity coordinates x, y, and the desired tolerance color spacing is ΔE. The non-standardized color valences of the target spectral locus are then given as:

$${X}^{′} = x , \qquad {Y}^{′} = y , \qquad {Z}^{′} = 1 - x - y ,$$

Standardization is performed under the customary assumption that D50 illumination is present, i.e., lighting with x(D50)=0.3457 and y(D50)=0.3585. The standardization factor N is then given by N=100/y(D50) and the following is true:

$$X = {X}^{′} * N \qquad Y = {Y}^{′} * N , \qquad Z = {Z}^{′} * N .$$

If the color distance tolerance ΔE is, e.g., performed in the CIELAB system, then the coordinates L₀*, a₀*, b₀* of the target spectral locus in the CIELAB color system are calculated from these standard valences X, Y, Z using the known conversion formulas. In these coordinates, the following color distance tolerance applies:

$$Δ E = √ ( Δ {L}^{* 2} + Δ {a}^{* 2} + Δ {b}^{* 2} ) .$$

Given the same brightness, i.e., ΔL*=0, the color distance tolerance describes a circle 42 in the a*, b* coordinate system with radius ΔE around the center point M with the coordinates (a₀*, b₀*) as illustrated in the diagram 40 of FIG. 4.

For example, four points on the circle circumference 42 that have the extreme values in the a*- or b*-coordinate can be selected as the boundary spectral loci G1-G4. Choosing the boundary spectral loci in this way results in:

$$G 1 : ( {a}_{{0}^{*}} + Δ E , {b}_{{0}^{*}} ) ,$$

$$G 2 : ( {a}_{{0}^{*}} - Δ E , {b}_{{0}^{*}} ) ,$$

$$G 3 : ( {a}_{{0}^{*}} , {b}_{{0}^{*}} + Δ E ) ,$$

$$G 4 : ( {a}_{{0}^{*}} , {b}_{{0}^{*}} - Δ E ) .$$

For a more precise boundary of the area enclosed by circle 42, further points on the circle circumference can also be selected as additional boundary spectral loci, such as along the diagonals of the a*-b* plane. A continuous calculation for the entire circle circumference is also possible. In another embodiment, it is possible to select only two boundary spectral loci, e.g., the points G1 and G3 specified hereinabove, which enables a particularly fast calculation. If only two lumines-cent pigments are used, then the luminescent color impressions that can be represented by their mixture form a straight line in the a*-b* plane, and the two intersection points of this straight line can, e.g., be selected with the circle 42 as the boundary spectral locus.

The coordinates of the boundary spectral loci G1 to G4 are then back-transformed into the XYZ color space, with the calculation returning to the assumed D50 illumination. With the standard valences found in this way, the standard valence fractions x, y, and from these, the non-standardized valences X′, Y′, Z′ are determined for the boundary spectral loci.

For each of the boundary spectral loci G1 to G4, one proceeds as described hereinabove regarding a specified diffuse reflectance color to determine the associated metering vectors. For example, when three luminescent pigments are specified for the basic colors red, green, and blue, the relative proportions by weight c_{R} (G1), c_{G} (G1), c_{B} (G1), . . . c_{R} (G4), c_{B} (G4) are respectively determined. From the values of these proportions by weight, a tolerance weight range for the three luminescent pigments can then be

$${c}_{R} ( min ) - {c}_{R} ( max ) ,$$

$${c}_{G} ( min ) - {c}_{G} ( max ) ,$$

$${c}_{B} ( min ) - {c}_{B} ( max ) ,$$

as appropriate.
For example, if only two boundary spectral loci, but at least three luminescent pigments are used, the tolerance weight ranges can be selected symmetrically around the proportions by weight c_{R}, c_{G}, c_{B} of the target spectral locus (a₀*, b₀*).

As a specific example, the color impression of an orange diffuse reflectance color with (x, y)_{target}=(0.48, 0.35) using, e.g., a luminescent color system is to be modeled. ΔE=1.0 is specified as the color distance tolerance, whereby the color distance tolerance ΔE in this embodiment is performed in the DIN99o color system according to DIN 6176.

For this purpose, the coordinates of the target spectral locus are first expressed in the DIN99o color system using the known conversion formulas, with the following result:

$${( {L}_{99 o} , {a}_{99 o} , {b}_{99 o} )}_{target} = ( 66.5193 , 30.7571 , 18.4952 ) .$$

In the DIN99o color system, the following color distance tolerance applies:

$$Δ E = √ ( Δ {{L}_{99 o}}^{2} + Δ {{a}_{99 o}}^{2} + Δ {{b}_{99 o}}^{2} ) ,$$

so, given the same brightness, i.e., ΔL₉₉ₒ=0, the color distance tolerance in the a₉₉ₒ-b₉₉ₒ plane describes a circle with radius ΔE=1.0 around the center point (a₉₉ₒ, b₉₉ₒ)_{target}=(30.7571, 18.4952).

If the four points on the circle circumference which have the extreme values in the a₉₉ₒ- or b₉₉ₒ—coordinate are selected as the boundary spectral locus G1-G4, then the coordinates of this boundary spectral locus result:

$$G 1 : ( 66.5193 , 30.7571 + 1 , 18.4952 ) = ( 66.5193 , 31.7571 , 18.4952 ) ,$$

$$G 2 : ( 66.5193 , 30.7571 - 1 , 18.4952 ) = ( 66.5193 , 29.7571 , 18.4952 ) ,$$

$$G 3 : ( 66.5193 , 30.7571 , 18.4952 + 1 ) = ( 66.5193 , 30.7571 , 19.4952 ) ,$$

$$G 4 : ( 66.5193 , 30.7571 , 18.4952 - 1 ) = ( 66.5193 , 30.7571 , 17.4952 ) .$$

After back-transformation of the coordinates of this boundary spectral loci G1 to G4 in the XYZ color space, one obtains x, y of these boundary coordinates for the standard chromaticity coordinates:

$$G 1 : ( 0.496447 , 0.354284 ) ,$$

$$G 2 : ( 0.484755 , 0.359488 ) ,$$

$$G 3 : ( 0.495624 , 0.359271 ) ,$$

$$G 4 : ( 0.485486 , 0.354607 ) .$$

The spectral locus associated with the center point of the circle in the a₉₉ₒ-b₉₉ₒ plane is exactly the desired target spectral locus:

$$M : ( 0.48 , 0.35 ) .$$

Then, for the boundary spectral loci G1 to G4 and the center point M, each of the metering vectors c(G1) to c(G4) and c(M) are determined with the relative proportions by weight of the three luminescent pigments, as described hereinabove. For example, when selecting the luminescent pigments P_{R}, P_{G}, P_{B} with the spectra shown schematically in FIG. 2 for the primary colors red, green, and blue, the relative proportions by weight given in Table I are obtained:

TABLE I

| | c_{R} | c_{G} | c_{B} |
|---|---|---|---|
| M | 9.42578 | 5.61483 | 1.0 |
| G1 | 9.88737 | 5.36473 | 1.0 |
| G2 | 8.99193 | 5.84185 | 1.0 |
| G3 | 10.4769 | 6.17029 | 1.0 |
| G4 | 8.54984 | 5.14565 | 1.0 |

In order to achieve absolute proportions by weight for pigmentation, the relative proportions by weight c_{R}, c_{G}, c_{B} are still appropriately scaled. For example, to adjust the specified orange diffuse reflectance color, the pigmentation of the red luminescent pigment P_{R} can be set to c_{R,abs}=5%. The pigmentation of the green and blue luminescent pigments P_{G} and P_{B} can in this case then be determined as explained hereinabove.

FIG. 5 shows in the diagram 50 the obtained absolute proportions by weight c_{G,abs}, c_{B,abs} of the green and blue luminescent pigments P_{G} and P_{B} for the center point M and the four boundary spectral loci G1 to G4. The weight fraction c_{R,abs} of the red luminescent pigment is 5% each due to the determination made.

In a practical test, five luminescent printing inks were mixed with the thus determined absolute proportions by weight according to the values of the center point M and the boundary spectral loci G1 to G4 and a printed pattern with the five luminescent printing inks was produced. Under excitation with UV light, the five luminescent printing inks all produced very similar luminescent printing inks, practically indistinguishable by the naked eye.

1.-13. (canceled)

14. A method for producing a luminescent printing ink for a desired target spectral locus, in which:
Z) the desired target spectral locus is specified using standard chromaticity coordinates x, y,
L) at least two luminescent pigments are specified by their luminescent spectra,
B) proportions by weight of the at least two luminescent pigments are determined from the luminescence spectra of the luminescent pigments, from spectral value functions, and from the specified target spectral locus, and
M) the at least two luminescent pigments are mixed in the proportions by weight determined in step B) in order to obtain a luminescent printing ink having a luminescence of which the spectral locus under non-visible excitation light corresponds substantially to the target spectral locus.

15. The method according to claim 14, wherein, during step L), exactly three luminescent pigments are specified.

16. The method according to claim 14, wherein the luminescent spectra of the luminescent pigments and the spectral value functions are each specified as a vector of n intensities at n set wavelengths and that, during step B),
B1) color valences X′, Y′, Z′ are determined from the standard chromaticity coordinates x, y of the specified target spectral locus,
B2) a luminescent color matrix is determined from the luminescent spectra of the luminescent pigments and the spectral value functions,
B3) the luminescent color matrix is inverted in order to obtain an inverse luminescent color matrix, and
B4) the relative proportions by weight of the at least two luminescent pigments are deter-mined from the inverse luminescent color matrix and the color valences X′, Y′ Z′ of the specified target spectral locus.

17. The method according to claim 14, wherein, during step M),
M1) an overall pigmentation of the luminescent pigments or a maximum pigmentation of one of the luminescent pigments is specified, and the absolute proportions by weight of the at least two luminescent pigments are thereby determined from the relative proportions by weight determined during step B), and
M2) the at least two luminescent pigments are mixed in the absolute proportions by weight determined during step M1 and introduced into a clear coat in order to obtain the luminescent printing ink.

18. The method according to claim 14, wherein
during step Z), a desired color distance tolerance to the target spectral locus is specified in addition to the desired target spectral locus,
during step B), while further using the specified color distance tolerance, a tolerance weight range for the relative weight fraction of each of the at least two luminescent pigments is in each case determined, and
during step M), the at least two luminescent pigments are mixed in proportions by weight, each within the tolerance weight ranges for the luminescent pigments, in order to obtain a luminescent printing ink having a luminescence of which the spectral locus under non-visible excitation light corresponds substantially to the desired target spectral locus.

19. The method according to claim 18, wherein during step B)
B0) at least two boundary spectral loci with standard chromaticity coordinates xG, yG are determined from the specified target spectral locus and the specified color distance tolerance,
B2) a luminescent color matrix is determined from the luminescent spectra of the luminescent pigments and the spectral value functions,
B3) the luminescent color matrix is inverted in order to obtain an inverse luminescent color matrix,
and, for each boundary spectral locus:
B1′) color valences XG′, YG′ ZG′ associated with the boundary spectral locus are determined from the standard chromaticity coordinates xG, yG,
B4′) from the inverse luminescent color matrix and the determined color valences XG′, YG′, ZG′ of the boundary spectral locus, relative proportions by weight associated with the at least two luminescent pigments are determined,
and then
B5′) from the relative proportions by weight of the at least two luminescent pigments for the boundary spectral loci, a tolerance weight range for the relative weight fraction of each of the at least two luminescent pigments are determined.

20. A method for generating a luminescent color image, in particular a multi-colored lumines-cent color image, during which method:
one or more of the luminescent colors found in the luminescent image is specified for a desired target spectral locus,
luminescent printing inks are produced for the specified target spectral loci, in each case using a method according to claim 14, and
the luminescent color image is printed using the luminescent printing inks produced.

21. The method according to claim 20, wherein
a multicolored diffuse reflectance color image is specified which, in visible light in different sub-areas, provides a color impression determined in each case by a spectral locus, and that
a luminescent color image is generated that reproduces the color impression of the diffuse reflectance color image by specifying the spectral loci of the diffuse reflectance color in visible light for the different sub-areas as the desired target spectral locus for the luminescent color.

22. The method according to claim 21, wherein the diffuse reflectance color image produced using diffuse reflectance printing inks and the luminescent color image produced using the luminescent printing inks are imprinted on the same target data storage means.

23. The method according to claim 20, wherein the luminescent color image is imprinted on the data storage means as a security element for securing a data storage means, in particular a valuable document or an identity document.

24. The method according to claim 22, wherein the diffuse reflectance color image and the luminescent color image are imprinted on the data storage means,
wherein the luminescent color image shows the same motif and provides the same color impression as the diffuse reflectance color image in visible light in order to secure the data storage means when illuminated by excitation light.

25. The printing ink according to a method according to claim 14.

26. A data storage means having an imprint comprising a printing ink according to claim 25.
